(19) United States
(12) Patent Application Publication
(10) Pub. No.: US 2011/0046915 A1
(43) Pub. Date: Feb. 24, 2011

(54) USE OF POSITIONING AIDING SYSTEM FOR INERTIAL MOTION CAPTURE

(75) Inventors: Jeroen D. Hol, Enschede (NL); Freerk Dijkstra, Hengelo (NL); Hendrik Johannes Luinge, Enschede (NL); Daniel Roetenberg, Enschede (NL); Per Johan Slycke, Schalkhaar (NL)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: XSENS HOLDING B.V., Enschede (NL)

(21) Appl. No.: 12/850,370

(22) Filed: Aug. 4, 2010

Related U.S. Application Data
(63) Continuation-in-part of application No. 12/534,607, filed on Aug. 3, 2009.
Application No. 12/534,607 is a continuation-in-part of application No. 12/534,526, filed on Aug. 3, 2009.
Application No. 12/534,526 is a continuation-in-part of application No. 11/748,963, filed on May 15, 2007.
(60) Provisional application No. 61/273,517, filed on Aug. 4, 2009.

(51) Int. Cl. G06F 15/00

(52) U.S. Cl. 702/150

(57) ABSTRACT

The invention provides robust real-time motion capture, using an inertial motion capture system, aided with a positioning system, of multiple closely interacting actors and to position the actor exactly in space with respect to a pre-defined reference frame. It is a further object of the invention to use such positioning systems to aid the inertial motion capture system that the known advantages of using inertial motion capture technology is not compromised to a great extent. Such positioning systems include pressure sensors, UWB positioning systems and GPS or other GNSS systems. It is a further object of the invention to avoid the use of the earth magnetic field as a reference direction as much as possible, due to the known problems of distortion thereof.

### CROSS-REFERENCE TO RELATED APPLICATIONS

This application claims the benefit of U.S. Provisional Application No. 61/273,517, filed Aug. 5, 2010. This application also is a continuation in part of U.S. application Ser. No. 12/534,607 filed Aug. 3, 2009, U.S. application Ser. No. 12/534,526, filed Aug. 3, 2009, and U.S. application Ser. No. 11/748,963, May 15, 2007, all of which are herein incorporated by reference in their entireties, for all that they teach, disclose, and suggest, without exclusion of any portion thereof.

### FIELD OF THE INVENTION

The invention pertains to the field of motion capture and, more particularly, to the use of a positioning aiding system concurrently with inertial motion capture systems.

### BACKGROUND OF THE INVENTION

In many fields, it is necessary or desirable to track the motion of an object, e.g., to analyze the motion or record an abstract of the motion. Although there are known methods of tracking motion via an external infrastructure of optical sensors, there are several benefits of using inertial motion tracking instead of optical tracking. Advantages include robust real-time tracking due to the absence of occlusion and marker swapping and the extremely large area tracking capabilities combined with the lack of a need for an installed infrastructure. However, unlike systems based on an installed infrastructure, an inertial based system will fundamentally build up position tracking errors over time and traversed distance.

Although the inventors hereof have used biomechanical joint constraints and physical external contact detection to resolve this problem to some extent, some degree of inertial position drift is present, and fundamentally unavoidable using solely inertial sensors, resulting in a horizontal position drift of the estimated movement of the characters over time as well as drift in traversed distance (typically 1% of traversed distance). For a single actor, this drift will not always be a problem. An animated environment could for example be adjusted to coincide with the actor's actions. Indeed, if the motion capture data is re-targeted to a character of a different size, this is the typical workflow anyway, even if the horizontal position tracking were perfect.

This option is not available when the interaction with the object is repeated after walking around or for real-time (pre) visualization purposes.

Moreover, in many applications, the simultaneous motion capture of a number of interacting actors is required. Correcting for multi-actor interaction in combination with movement of the actors is very difficult because the actors will not experience the same drift. This has heightened consequences when the actors interact with each other. To a certain extent, the relative drift can be corrected during post-processing (i.e., by editing foot contacts) to have the actors interact properly later on. However, this corrective action involves additional work and does not permit real-time visualization.

One way to mitigate drift is to use an external force such as the measured gravitational acceleration to provide a reference direction. In particular, the magnetic field sensors determine the earth's magnetic field as a reference for the forward direction in the horizontal plane (north), also known as “heading.” The sensors measure the motion of the segment on which they are attached, independently of other system with respect to an earth-fixed reference system. The sensors consist of gyroscopes, which measure angular velocities, accelerometers, which measure accelerations including gravity, and magnetometers measuring the earth magnetic field. When it is known to which body segment a sensor is attached, and when the orientation of the sensor with respect to the segments and joints is known, the orientation of the segments can be expressed in the global frame. By using the calculated orientations of individual body segments and the knowledge about the segment lengths, orientation between segments can be estimated and a position of the segments can be derived under strict assumptions of a linked kinematic chain (constrained articulated model). This method is well-known in the art and assumes a fully constrained articulated rigid body in which the joints only have rotational degrees of freedom.

The need to utilize the earth magnetic field as a reference is cumbersome, however, since the earth magnetic field can be heavily distorted inside buildings, or in the vicinity of cars, bikes, furniture and other objects containing magnetic materials or generating their own magnetic fields, such as motors, loudspeakers, TVs, etc.

### SUMMARY OF THE INVENTION

It is an object of the invention to support robust real-time motion capture, using an inertial motion capture system, aided with a positioning system, of multiple closely interacting actors and to position the actor exactly in space with respect to a pre-defined reference frame. It is a further object of the invention to track or locate floors, walls or other objects in general in the motion capture volume to further improve the robustness and accuracy of the system without increasing demands for very high accuracy positioning systems. It is a further object of the invention to use such positioning systems to aid the inertial motion capture system that the known advantages of using inertial motion capture technology is not compromised to a great extent. It is disclosed that such positioning systems include pressure sensors, UWB positioning systems and GPS or other GNSS systems. It is a further object of the invention to avoid the use of the earth magnetic field as a reference direction as much as possible, due to the known problems of distortion thereof. Suitable use of kinematic coupling algorithms using inertial sensors is disclosed, including use on subsegments of a body, such as for example only the leg

For fully ambulatory motion capture systems that do not require horizontal plane position tracking, but have requirements for vertical position tracking, the system can be extended using pressure sensors, optionally using one or more reference pressure sensors at known altitudes. Such systems can not only be used in the atmosphere but are also suitable for accurate tracking of depth under water. In a preferred embodiment of the invention each body segment is fitted with an inertial sensor and at that same location is also fitted a pressure sensor.

For use outside of an inertial motion capture system it is preferred to extend the system using position aiding based on global navigation satellite systems (GNSS) such as GPS. Although with systems such as GPS, position estimates can be obtained that are accurate, it may be preferable to rely additionally on GPS velocity aiding of the inertial motion capture system since GPS systems are capable of accurate velocity estimates.

Especially for larger set-ups indoors or other locations where GPS or other GNSS systems are not available, or applications outdoors that require higher positional accuracy than can be obtained using GPS, and applications that require horizontal position tracking, the use of UWB positioning systems provides distinctive benefits that are unforeseen in the art compared to the other mentioned positioning technologies. For example, it does not necessarily require line of-sight and is therefore much more robust to occlusion than optical systems. Moreover, large motion capture areas can be constructed for only a fraction of the costs and installed hardware compared to optical systems, and due to the low installed hardware intensity per motion capture area, the system is easy to set-up and re-locate. The system is easy scalable to very large volumes and does not suffer from restrictions in lighting conditions or other environmental conditions (e.g., air pressure, moisture, temperature). Moreover, the inventors have found that a much higher degree of robustness is unexpectedly achieved with described system compared to other RF-based positioning options.

Instead of physically aligning a magnetometer (electromagnetic compass) to the reader setup, the direction of the magnetic field with respect to the setup can be determined using a device containing an inertial sensor/UWB tag combination as described in U.S. patent application Ser. No. 12/534,607 filed Aug. 3, 2009. This device could be used to determine the direction of the magnetic field over the motion capture volume prior to performing a motion capture. However, to account for local deviations in the earth magnetic field as well as to relieve the user from performing an additional calibration, the combined inertial sensor/UWB device could also be placed on the body as to dynamically track the local magnetic field with respect to the UWB system. The inertiaUUWB device should be mounted sufficiently close to the segment(s) for which the magnetic field update is to be applied to ensure that the magnetic field at the device is representative for the magnetic field at the segment.

In some cases the inertial/UWB device can not be placed sufficiently close to the segment for which the heading is to be determined. This is the case e.g. when the UWB tag is to be placed on the head while moving on a floor containing steel reinforcements. In this case, the local magnetic field around the legs is disturbed and not representative for the (earth) magnetic field near the head.

If this is the case, the heading between each of the legs and upper body can be made observable by considering the connection between these three. The linkage between the legs is obviously the pelvis. By feeding the velocity of both legs to the pelvis sensor and feeding the velocity after the biomechanical fusion engine update back to the legs, the orientation of lower body is consistent without magnetometers. This interrelationship can be seen in FIG. 13. Note that this latter implementation can also be used to obtain consistent heading within the body without using input from the UWB system.

Moreover, although the UWB signal does not require line of sight (LOS) for positioning, the signal is delayed when travelling through body parts, causing the positioning to shift a little away from the reader that was blocked. Absorption of the LOS signal might also cause the signal to noise ratio to drop, causing more noise in the TOA and/or causing a signal-lock to a reflection. However, since in the use of an inertial motion capture system the position of all body parts, and their size and orientation is known, and the location of the UWB Tags on the body and UWB Readers are known, it is possible to “ray-trace” the path between the Tag and the Reader and check if a body part, and if so which and its orientation, is in the path of the “ray”, i.e. the UWB RF pulse. Combined with the UWB system RSSI (Received Signal Strength Indicator), a very robust measure can be obtained for the likelihood of a multi-path (reflection) UWB measurement, or if the UWB signal from the Tag is likely to have been absorbed or delayed due to the transmission through the human body. In such a case the time delay caused by the path length through the body, which has a refraction index close to that of water, can be accurately estimated. This estimate can be accurate because the size, position and orientation of the body segment is known (tracked). The advantage of this approach is that the UWB measurement can still be used accurately and does not have to be discarded because it has been transmitted through the human body.

Whenever the UWB aiding system is temporarily not consistent with the position solution obtained from inertial sensors and biomechanical relations, state augmentation can be used to temporarily bridge the inconsistency as to ensure a smooth animation and overcome incidental errors that could be caused by e.g. wrong footstep detection.

For reasons of e.g. optimal line of sight, it may not always be desirable to mount the tag in the same position as the inertial sensor units. In case a tag is not mounted near the inertial sensor units, or not even on the same segment, the lever arm between the inertial sensor and the tag has to be taken into account. Computation of this arm may involve the crossing of different segments with known orientation, including modeling of uncertainties therein, e.g., the pelvis orientation and position could be determined using a) the algorithm described in U.S. application Ser. No. 12/534,526, filed Aug. 3, 2009, b) inertial sensor information from the inertial sensor unit mounted on the pelvis c) UWB readings taken from the tag on the head and d) taking into account the dynamically changing vector between the pelvis and the head, computed using different inertial sensor units.

### BRIEF DESCRIPTION OF THE DRAWINGS

FIG. 1 is a schematic illustration of a body of interest including several UWB transmitters;

FIG. 2 is a schematic diagram of a 3D set-up within which the invention may be implemented;

FIG. 3 is a top view of the achievable accuracy for a minimal UWB constellation according to an embodiment of the invention;

FIG. 4 is top view illustrating the way in which, because the readers have omni-directional antennas, the area in which UWB position tracking can be done extends beyond the square created by the readers;

FIG. 5 is a top view of the achievable accuracy for a 12-reader UWB constellation according to an embodiment of the invention;

FIG. 6 is a top view of the achievable accuracy for a customized UWB constellation according to an embodiment of the invention;

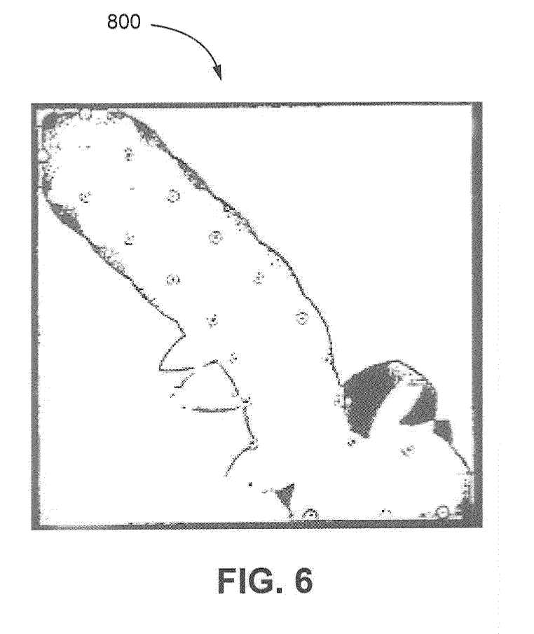

FIG. 7 is a schematic diagram of a 2D set-up within which height resolution may be aided in an embodiment of the invention;

FIG. 8 is a top view showing achievable positioning accuracy of a minimal constellation of 4 readers using “height aiding” in an embodiment of the invention;

FIG. 9 is a drawing detailing the direction of the local magnetic field with respect to the position reference system;

FIG. 10 shows an example configuration of the UWB setup;

FIG. 11 shows an example of a delay in signal propagation as well as an example of multipath;

FIG. 12 shows that the time of arrival (TOA) of a pulse emitted by an UWB tag does not change much with the height of the tag;

FIG. 13 is a schematic body diagram showing the interrelationship of the heading between each of the legs and upper body;

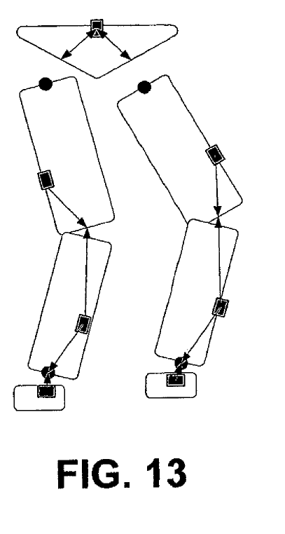

FIG. 14 is a top view of a set-up containing two planar surfaces;

FIG. 15 is a flow diagram showing the stages of locating surfaces such as shown in FIG. 14;

FIG. 16 shows a schematic as an example of objects that can be located in the environment using position trackers and/or inertial measurement units to track position and orientation of objects, that can also serve as a modeled object in the processing of the data to detect contact of the actor being tracked with the external world; and

FIG. 17 is a schematic illustration of a position correction from e.g. an UWB system. Such a correction will typically lead to, or take the form of, a correction of one of the poses of the different segments.

### DETAILED DESCRIPTION OF THE DRAWINGS

Before discussing the overall system, this section gives some basic technical background for basic UWB positioning systems in order to give the reader an understanding of the capabilities and limitations of such systems. In a UWB positioning set-up, a small and mobile radio transmitter, or tag, periodically (e.g., 10 times per second) emits a burst RF-signal. This signal travels with the speed of light (˜300,000 km/s) in the ambient medium (largely air) to receivers, or readers installed at fixed locations around the motion caption area.

The UWB RF-signal comprises a series of very short (nano second) EM-pulses that contains the unique ID of the tag. Because of the wide-band nature of the signal, the reader can determine the exact time at which the signal is received. The clock of the reader is sufficiently precise so as to determine the time-of-arrival (TOA) with a resolution of about 39 picoseconds (10⁻¹² seconds).

Although the signal travels very fast, it will take time for the signal to travel from the tag to a reader. For example, in the minimum time step that the reader can measure of 39 picoseconds it will travel approximately 1 cm. Thus, the system positioning resolution is about 1 cm.

So, if the reader could know the exact time at which the tag transmitted the signal, simply taking the difference between this time-of-transmission (TOT) and the TOA would give the time passed since the signal was transmitted, i.e., the time-of-flight (TOF). Theoretically, this could then be used to calculate the range, as it is simply the speed of light times the TOF. Unfortunately, the reader does not know the TOT, because it has no knowledge of the internal clock of the tag. Therefore, one reader alone will not give any range information. However, if a configuration is created with a number of synchronized readers, the TOA at each reader will differ from the other reader with a measure of the difference in the distance to the tag. Unfortunately, the reader does not know the TOT, because it has no knowledge of the internal clock of the tag. Therefore, one reader alone will not give any range information. However, if a configuration is created with a number of synchronized readers, the TOA at each reader will differ from the other reader with a measure of the difference in the distance to the tag.

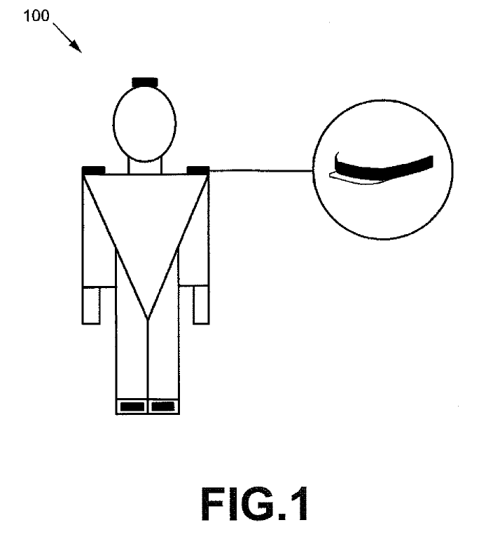

Referring to an exemplary environment, the body of interest 100, e.g., and actor, is outfitted with one or several transmitters (tags). The transmissions of the tags are picked up by a set of readers (not shown in FIG. 1) placed in the motion capture area. Each reader may weigh about 1.4 kg and be about 20.3 cm high with a diameter of 33 cm. The readers can be mounted on tripods, attached to walls or ceiling or placed on the floor.

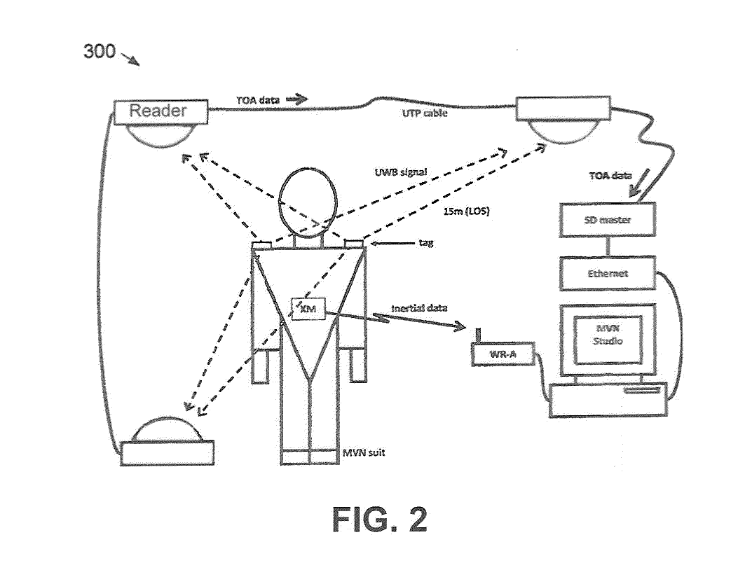

An entire system implementation according to an embodiment of the invention is illustrated schematically in FIG. 2 as system 300. Unlike optical systems, the UWB augmentation of the system offers a great deal of flexibility to the user to cover the motion capture area. The area within which accurate drift free position information can be obtained is limited by the range of the readers and the achievable accuracy is largely determined by the relative geometry of the reader configuration, also known as constellation as will be discussed in greater detail below.

A tag (also named transmitter) emits a short pulse (nanosecond duration) at some initially unknown time TOE (time of emission). This pulse is received by different receivers (readers) at different times (because of the speed of light and the different distances of the tag to each of the receivers, see arrows with dashed lines). The reader clocks are synchronized to high accuracy using a master clock device. The time of arrival (TOA) of this pulse at the different receivers is recorded and send to a PC.

For synchronization the readers are connected to a Synchronization and Distribution (SD) master, i.e. a master clock device. Via this connection the SD master also powers (Power-over-Ethernet) the readers in an embodiment of the invention. The SD master is connected to a local Ethernet and serves as a transparent link for the readers to transmit UDP packets containing the TOA to the motion capture system. Given the different TOA's, and optionally inertial sensor signals and height input, the position of the tag is computed. This position is in turn used to correct any positional drift in the movement that is tracked (using software we named MVN studio).

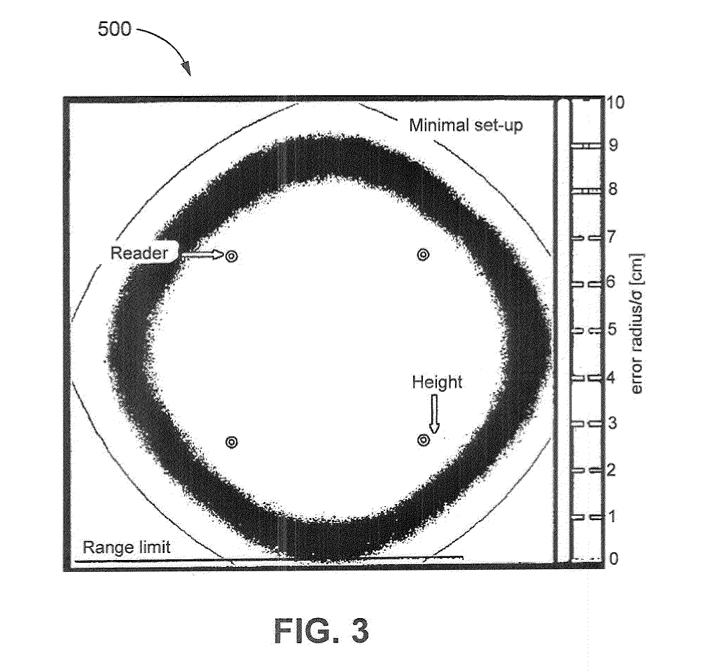

To determine a 3D position, at least 4 readers are required. So, the minimal set-up is created with four readers, two of which are preferably placed on the floor and two on the ceiling. The resulting accuracy of the UWB position information that is used for drift correction is given in FIG. 3, which is a top view of the achievable accuracy for a minimal UWB constellation. In this figure the achievable accuracy is defined as the standard deviation o of the intrinsic noise in the range from a tag to a reader (around 3 cm) multiplied by the dilution of precision (DoP) due to the reader constellation (geometry). The minimum dilution of precision due to the geometry (DoP) is achieved in the center of the configuration (green area) and is about 1.3. The total achievable error is then typically 1.3*3=4 cm 1 sigma circular error probability.

As can be seen from FIG. 3, because the readers have omni-directional antennas, the area in which UWB position tracking can be done extends beyond the square created by the readers. This may be counter-intuitive to those experienced with optical based motion caption systems where the motion capture volume is often significantly smaller than the volume bounded by the mounting points of the cameras. In practice, this can translate to significant savings on sq·ft/m rent per motion capture volume.

The robustness of the minimal set-up is limited since at least 4 readers are required to calculate a stable position. This means that if any reader is blocked, e.g, due to absorption of the transmitted RF-pulse, a full solution can not be calculated. Moreover, the theoretical limitation, the DoP, of the achievable accuracy is larger when the number of readers is increased.

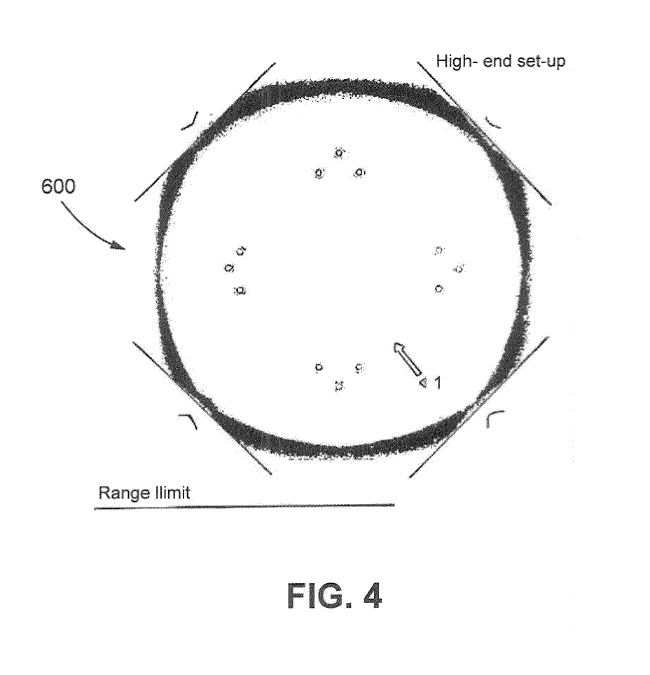

A more robust and accurate UWB constellation 700 is shown in FIG. 4. In particular, the UWB constellation 700 is a high-end 12-reader constellation. Inside the blue circle the geometric DoP is smaller than 1, resulting in an achievable accuracy better than the intrinsic noise of the raw TOA signal.

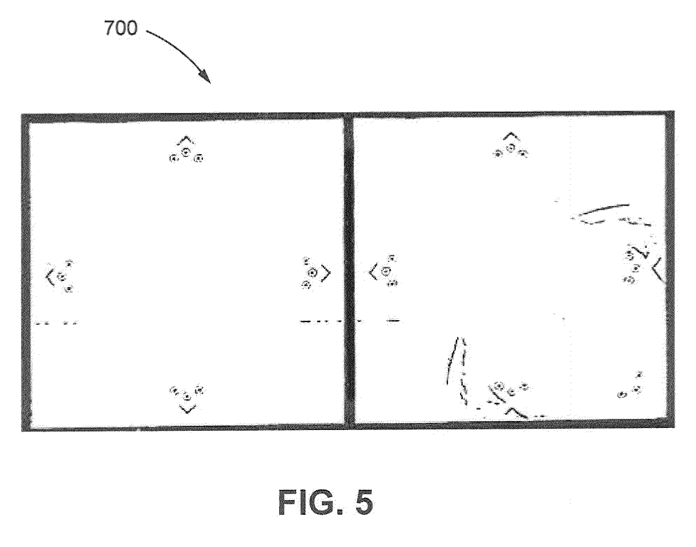

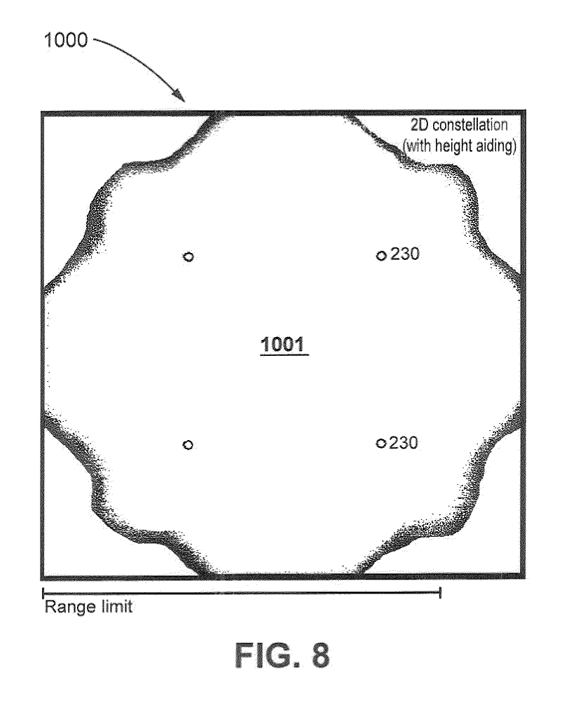

The configurations displayed in the previous sections are influenced by the range limit of the readers. However, it is possible to extend the area to beyond the range of the individual readers as illustrated in FIG. 5 via configuration 700. As this shows, due to the flexibility, the readers can also be placed to cover oddly shaped motion capture areas such as area 801 in FIG. 8.

Another environment within which the present system is advantageous is that of a stage such as a movie stage. In such environments, it is generally a requirement that an unobstructed view to one side is created so that no readers are in the view of the scene camera. It is important to note that in the examples above, the actual motion capture area may be much larger than the area in which accurate drift correction can be performed. The total motion capture area is only limited by the range of the wireless receivers. Thus, the actor is not restricted to the drift-free area but can wander outside the area if no interaction with other objects is required outside the area. Once the actor re-enters the drift-free area the position of the MVN character is gradually converged back to the actual position.

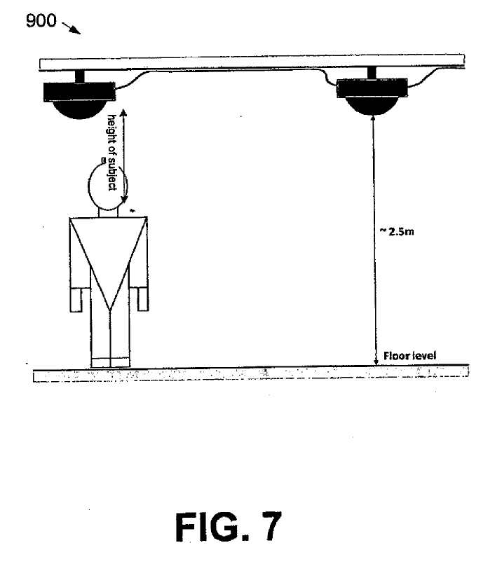

The illustrated constellations to this point have been 3D constellations, meaning that there are readers present above and below the area. However, it might not always be possible to create such a constellation. For example, in some cases it is only possible to create a minimal constellation in which the readers are fixed to the ceiling as illustrated in FIG. 7. In those situations a 3D position is difficult to calculate accurately. To support such 2D constellations, the system can use the height as it is estimated from the inertial portions or other portions of the system. In particular, if the height from the tag to the reader plane can be input to the positioning algorithm, the accuracy in all directions increases dramatically. For example, if the tagged actor is walking on a flat floor, the height of the body part on which the tag is mounted is known. Alternatively, the height can be computed using a pressure sensor. However, derived, the height is then used in the algorithm determining the position. For a minimal constellation this ‘dynamic height-aiding’ results in a positioning accuracy as given in FIG. 8, which shows an achievable positioning accuracy of a minimal constellation of 4 readers using “height aiding.” In the central portion 1001, the accuracy is about 2-3 cm.

As described in the related applications, the integration of the UWB positioning data with the inertial system uses very advanced algorithms to combine the UWB TOA data on the very lowest level with the inertial data. This method is known as “tight coupling.” This means that the system does not first calculate a position based on UWB only and subsequently combine that position with the inertial data. Instead, each individual UWB measurement (TOA) is used directly in the algorithm, yielding superior robustness, accuracy and coverage.

It has been discussed and illustrated above how the readers could be placed (the constellation) and how this influences the achievable accuracy of position tracking. However, once a constellation is selected, the readers must still be physically mounted in the area and the positions of the readers must be accurate recorded or determined while doing so. Also, for synchronization, the system needs to determine the clock-offset for each reader to a level of picosecond accuracy, which depends on cabling lengths and associated delays of the synchronization signal (speed of light).

In an embodiment of the invention, the described system is used in conjunction with one or more traditional systems such as optical tracking and/or computer vision based tracking. Optical tracking can deliver the required sub-millimeter accuracy needed for some applications, but it can not do so robustly. Computer vision based image tracking is important because it can deliver “through the lens” tracking. Even though sometimes quite inaccurate, this is important in practice because the perceived accuracy (in the image plane) is automatically “optimized” resulting in a readily visually acceptable image.

There are two issues related to defining planes in the described system, including measuring the height of the plane and determining the location and orientation of the plane. With respect to measuring the height of the plane, pressure sensors (optionally differential) may be used to alleviate/reduce the need for a full 3D setup of readers. This implementation requires the tags to be equipped with a barometer and requires integration of the associated data in the transmitted packet of the tag.

With respect to determining the location and orientation of the plane, this is performed automatically in an embodiment of the invention as follows. First, the surfaces are placed in the set-up. Tags are then placed at the corners of the surfaces and are detected using the default height of the location algorithm, and the tags corresponding to the same surface are linked together automatically or by hand. Due to the default height, the location of the tags have an offset. The height of the tags is then defined, e.g., by defining the height of the corresponding surface in case of a horizontal surface, and this information is used to create the objects in the virtual representation which can then additionally be used for external contact detection. If the user wants to use an arbitrary shaped plane, tags can be attached at precisely defined positions on the plane.

It is also possible to integrate props into the system by attaching an IMU to a freely moveable object, the IMU being equipped with a tag as well. Again, it should be noted that the vertical position of the prop is not known, so that either a 3D set-up must be created or additional algorithms are used to determine whether an actor picks up the prop in which case the movement of the prop becomes part of the motion model of the actor. Alternatively, a pressure sensor can aid in vertical location resolution.

There are a number of ways to place readers, but consider a configuration in which readers are placed on high tripods. With respect to this set-up there are the following advantages compared to motion caption systems: (1) The number of readers is low; for an area of approximately 15×15 meters only 4 readers are required (3 will also do, but will be less robust); (2) More readers can be placed to increase accuracy, but are redundant; (3) Larger area can be covered; (4) although the number of readers is low for a basic set-up, the number of readers is not limited; (5) If required, an arbitrarily large area can be covered, divided in, for example, cells of 15×15 meters; (6) Cost—a reader can be offered at a much lower price compared to a high speed camera.

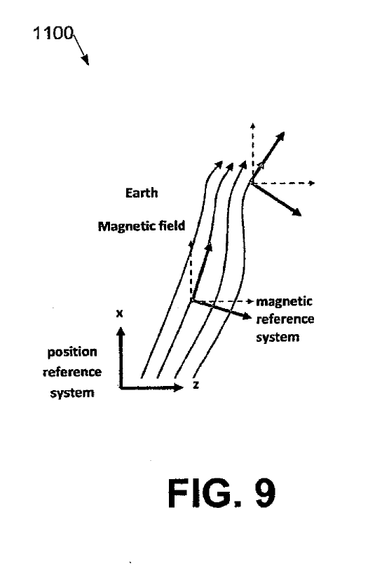

FIG. 9 shows how the local (earth) magnetic field may differ through the motion capture volume. The direction of the local magnetic field with respect to the position reference must be known to be able to use magnetometers to determine heading with respect to the positioning reference. This direction of the local magnetic field can be obtained using e.g. a device containing a combination of inertial sensors and an UWB tag.

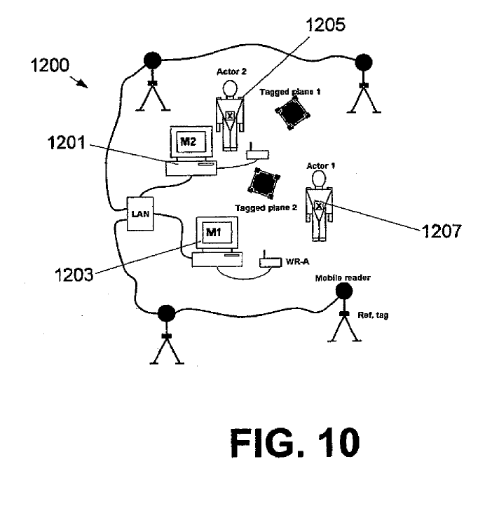

FIG. 10 shows an example configuration 1200 for the MVN using UWB prototype set-up. In the set-up, there is a MVN configuration 1201, 1203 (laptop running a motion capture studio application) for each actor 1205, 1207 respectively. However, it is important to visualize the two actors 1205, 1207 together. To implement this, it must be possible to stream the data between the applications. This link is implemented via UDP messages in an embodiment of the invention. The system also employs a fixed LAN set-up having two main data-streams, i.e., the TOA packets from the readers to the master studio application(s) 1201, 1203 and the studio data-stream from the secondary studio application 1203 to the master studio application 1201.

To be able to set a height reference, the configuration information defines the ID of the tag for each shoulder of the tagged actor 1205, 1207. Then, using the body model, the heights are determined for the shoulder tags and the heights are sent to the TDOA location algorithm which uses the heights to calculate the locations of the shoulder tags. The determined locations are then sent back for use in the virtual body model where they can be used in the position aiding algorithm.

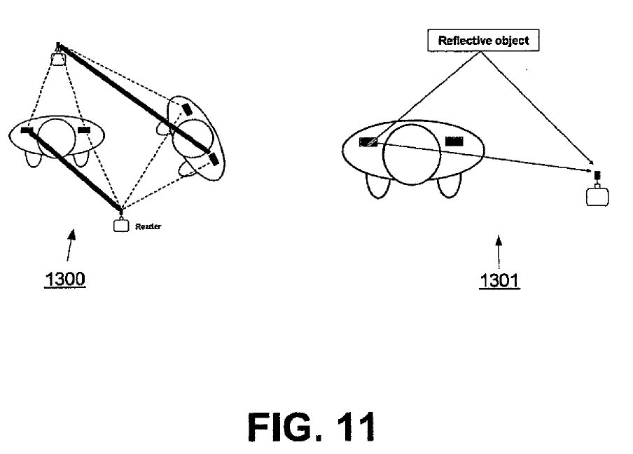

Referring to FIG. 11, although the UWB signal does not require LOS for positioning, the radio frequency signals are delayed when travelling through body parts. In particular, as shown, in the left-hand view 1300, signals that travel through the body (thicker lines) are attenuated and delayed as compared to signals that travel in air between the sender and receiver (solid straight lines). As shown in the right-hand view 1301, there may also be a dominant reflection with respect to an indirect path of the signal in air.

The speed of light in a body is approximately half the speed of light in vacuum due to the refraction index of the body, which is mainly water. Other materials such as glass also cause a time delay in the signal due to the refraction index. This causes the positioning to shift slightly away from the reader that was blocked by body parts, since the position is derived from the Time of Arrival (TOA) compared between different readers. Moreover, absorption of the LOS signal might cause the signal to noise ratio to drop. This can have two effects: more noise in the TOA and a signal-lock to a reflection as shown in view 1301.

However, since the position of all body parts, and their size and orientation is known, and the location of the UWB Tags on the body and UWB Readers are known, it is possible to “ray-trace” the path between the Tag and the Reader and check if a body part, and if so which and its orientation, is in the path of the “ray”, i.e., the UWB RF pulse. Combined with the UWB system RSSI (Received Signal Strength Indicator), a very robust measure can be obtained for the likelihood of a multi-path (reflection) UWB measurement, or if the UWB signal from the Tag is likely to have been absorbed or delayed due to the transmission through the human body. In such a case the time delay caused by the path length through the body, which has a refraction index close to that of water, can be accurately estimated. This estimate can be accurate because the size, position and orientation of the body segment is known (tracked). The advantage of this approach is that the UWB measurement can still be used accurately and does not have to be discarded simply because it has been transmitted through the human body.

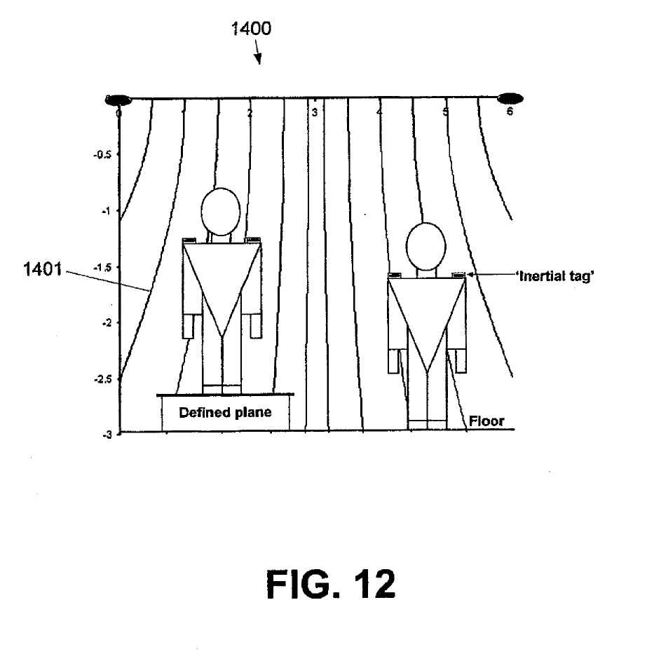

Referring now to FIG. 12, for a typical setup, the time of arrival readings by the UWB system are relatively constant for changes in height as compared to changes in horizontal position. This is illustrated by the lines of constant TOA 1401 in the schematic 1400 of FIG. 12.

It is possible to define contact points within the studio and to define planes by defining the z-coordinate as a function of the horizontal position. Normally, this will only work in a limited number of scenarios with no magnetic disturbances, slow movement and during short periods. In all other cases, the exact position is not known without a proper location system.

With the exact location available using the inertial motion capture system utilizing UWB positioning set-up, it makes sense to use this feature in the fusion software. There are two issues related to defining planes, for the purpose of external contact detection, in inertial motion capture systems, namely measuring the height of the plane and determining the location and orientation of the plane. Measuring the height of the plane is something that could be left to the user as it is a simple action. However, as was stated during the discussion of the requirements, preferably not of course; it does introduce a possibility of user-error and a time load on the user to have to measure manually. Another option is to use pressure sensors (optionally differential) to alleviate/reduce the need for a full 3D setup of readers. This would of course require the tags to be equipped with a barometer and integrate the measurement in the transmitted packet of the tag.

Determining the location and orientation of the plane is something that should not be left to the user without requiring the user to survey the position of the plane and determine the exact orientation and setting the parameters in MVN Studio. So, preferably, this is done automatically. In the following section it is explained how this can be done.

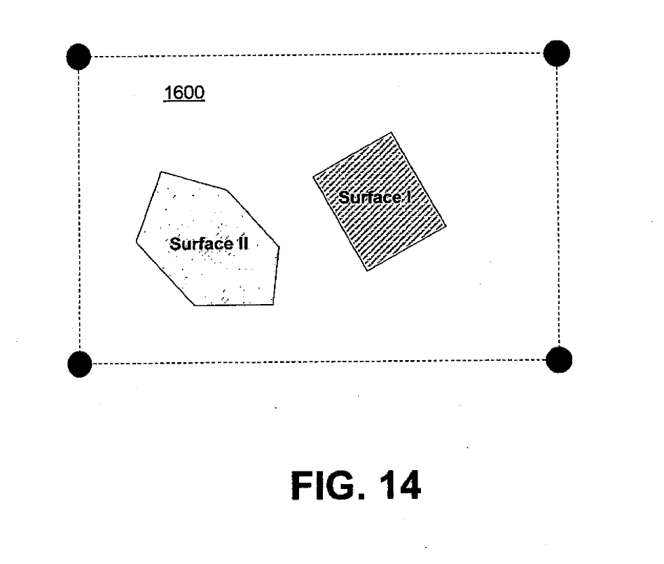

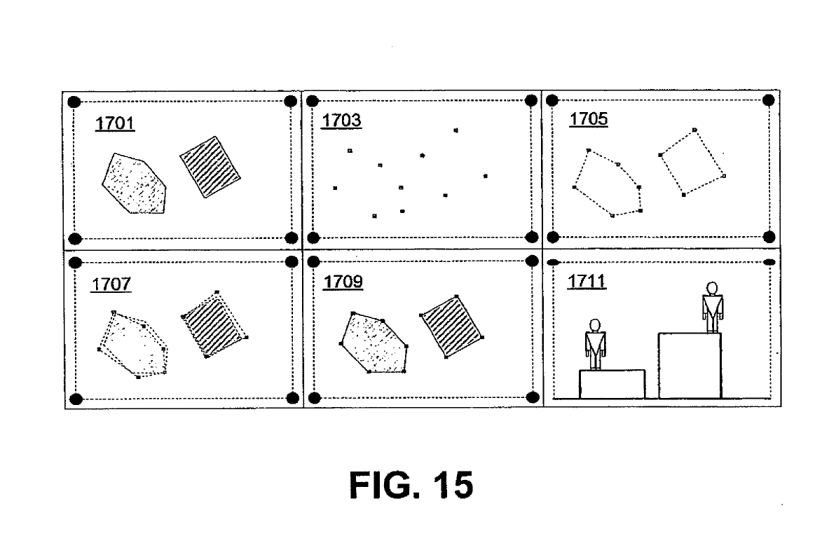

By way of example, consider the set-up 1600 as illustrated in FIG. 14. The workflow to get the automatic plane definition is illustrated schematically in FIG. 15. In particular, at stage 1701, the surfaces are placed in the set-up, and tags placed at the corners of the surfaces are detected using the default height of the location algorithm at stage 1703. Next at stage 1705, the tags corresponding to the same surface are linked together. This could be done automatically or by hand. Due to the default height, the locations of the tags have an offset (stage 1707) The height of the tags is defined, e.g. by defining the height of the corresponding surface in case of a horizontal surface at stage 1709, and the resultant information is used to create the virtual objects in the studio application.

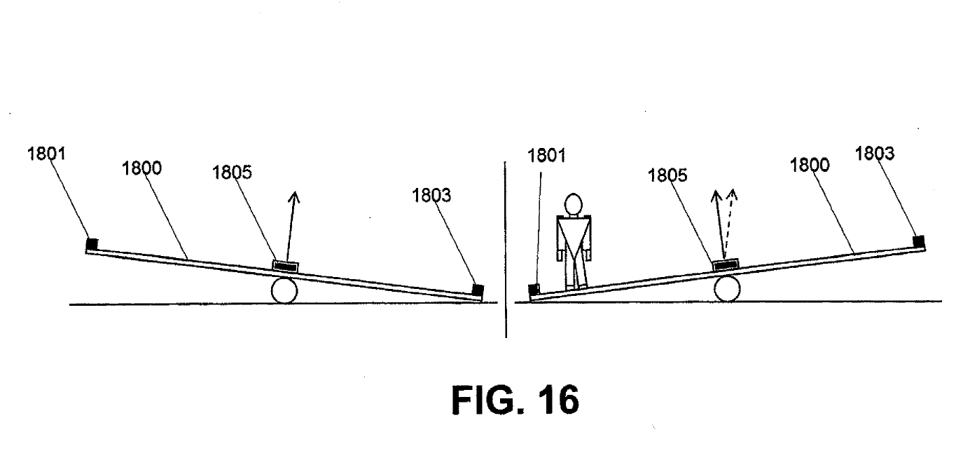

In an embodiment of the invention, the objects that create the plane (e.g. a table) can be moved around, and the changed location is determined automatically. The delay depends on the desired averaging to acquire the required accuracy. It will be appreciated that attached tags can be used to determine the position and orientation of an arbitrary shaped plane as well. If the user wants to use an arbitrary shaped plane, tags can be attached at precisely defined positions on the plane. Such a plane may be defined in any suitable way by the application, e.g., via polynomial definition. FIG. 16 shows an interaction of an actor with a dynamic plane 1800. In this example the position sensors (UWB) 1801, 1803 are located apart from the IMU 1805.

It will be appreciated that since it is, with this innovation, now possible to locate objects by using the location system, it is also possible to integrate wireless IMUs into MVN and have actors interact with objects to which this IMU is attached. Other advantages, features and consequences of the invention will be appreciated by those of skill in the art from the description herein.

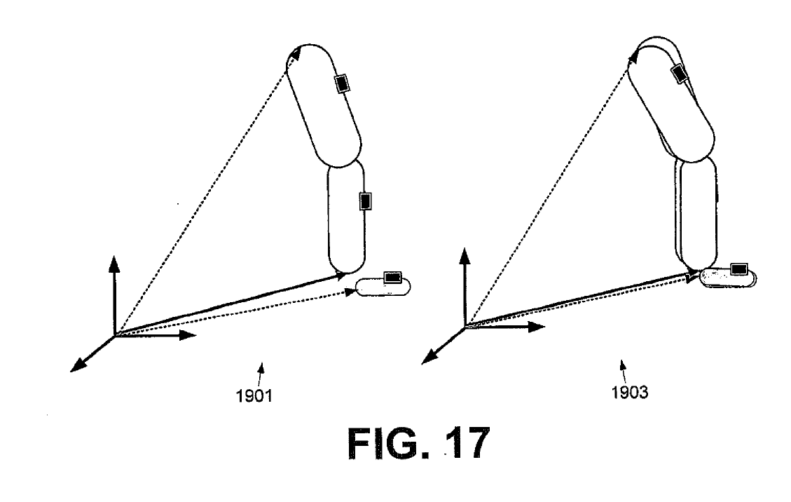

FIG. 17 is a schematic illustration of a position correction from e.g. an UWB system. Such a correction will typically lead to, or take the form of, a correction of one of the poses of the different segments. To maintain a consistent body model, a correction can then be fed through the different segments. In particular, FIG. 17 shows in the left-hand plat 1901 that in the illustrated situation, a position correction on a foot sensor leads to an unrealistic gap in the ankle joint. To resolve this inconsistency, all body segments could be translated as to close this gap. However this would lead to a sudden and incorrect shift of the entire body movement. A preferred method is to adjust the position and orientation of each of the segments to close the ankle gap. This can be done taking into account the qualities of the different sensors and biomechanical assumptions that are used for tracking. The correction could be implemented using a so-called inverse kinematics method or using a Kalman filter.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Certain examples of the invention are described herein, including the best mode known to the inventors for carrying out the invention. Variations of those examples will be apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. An inertial motion capture method for determining a position of a segmented object, the method comprising:
determining an estimate of a plurality of body segments of the object in a pre-defined coordinate system using position aiding;
deriving an inertial estimate of the plurality of body segments of the object, wherein the inertial estimates and position aiding estimates exhibit a difference there between;
resolving the difference in body segment position estimates from the inertial estimates and the position aiding estimates using constraints imposed by a biomechanical model by one or more of:
i. adjusting the estimated body segment positions,
ii. adjusting the estimated body segment orientations,
iii. adjusting the estimated or predefined alignment orientation between inertial sensor and body segment, in particular using a model of soft tissue deformations,
iv. performing state augmentation to account for temporal or spatial measurement errors in the positioning system; and
using KiC to estimate relative segment orientations without use of magnetometers.

2. The method according to claim 1 wherein determining an estimate of a plurality of body segments of the object in a pre-defined coordinate system using position aiding comprises using a position aiding system selected from the group consisting of: a pressure sensor, GPS, UWB, one or more optical sensors, and a combination of one or more of a pressure sensor, GPS, UWB, and one or more optical sensors.

3. The method according to claim 1 wherein determining an estimate of a plurality of body segments of the object in a pre-defined coordinate system using position aiding comprises using a pressure sensor on each body segment, the method further including:
adding a reference pressure sensor at a known location and altitude, and
using a pressure sensor in conjunction with UWB.

4. The method according to claim 1, wherein the position aiding system is UWB, the method further including obtaining height aiding from the inertial system including a biomechanical body model and external world contact detection for enabling the estimation of position from UWB measurements.

5. The method according to claim 1, wherein the position aiding system is UWB, the method further including obtaining height aiding from the inertial system including a biomechanical body model and external world contact detection for enabling the estimation of position from UWB measurements.

6. The method according to claim 1, wherein the position system is used to continuously obtain a direction of a local magnetic field with respect to the average direction of the magnetic field in the volume as a function of position in the volume to enable accurate magnetic tracking of the yaw, providing a consistent reference direction.

7. The method according to claim 1, wherein using the position system to obtain a model of the space being captured includes prior knowledge of a position in space of one or more reference surfaces.

8. The method according to claim 7, wherein the positioning system is incapable of tracking vertical position with an accuracy at least two times worse than horizontal accuracy.

9. The method according to claim 1, further comprising using the position system to track moving planes, objects or walls for the purpose of external contact detection.

10. The method according to claim 1, including using the position system to improve the position estimates of multiple entities in the space.

11. The method according to claim 1, further comprising using the position system to track freely moving props in the space of a person being tracked when the positioning system used is UWB.

12. The method according to claim 11, wherein at least one of the props being tracked includes a camera.

13. The method according to claim 1, further including using the position system in the evaluation of external contact detection between the model of the body being tracked and the external world, enabling contact models to include sliding and/or soft floors.

14. The method according to claim 1, further including using velocity estimates of a part of the body resulting from the use of a position aiding system as input to the KiC algorithm for each of the legs to achieve consistent relative orientation between the legs without the use magnetic field sensors.

15. The method according to claim 1, wherein the part of the body includes the pelvis.

16. An inertial motion capture method for determining a position of a segmented object having interconnected segments, each segment having an orientation and position, and having a transmitter thereon, the method comprising:
determining segment positions and orientations based on signals received from the transmitters;
calculating a deviation from the determined positions and orientation based on an interaction between the object and the signals of the sensors and the orientation and position of the transmitters with respect to the receiver; and
deriving final segment position and orientation values based on the determined segment positions and orientations and the calculated deviation.
